(19) United States
(12) Patent Application Publication
(10) Pub. No.: US 2010/0247278 A1
(43) Pub. Date: Sep. 30, 2010

(54) APPARATUS AND METHOD FOR EJECTING A PAYLOAD FROM A MOBILE UNIT

(76) Inventors: Eric C. Beck, Colts Neck, NJ (US); Theodore Sizer, Littlel Silver, NJ (US); Cuong Tran, Howell, NJ (US); Susan J. Walker, Freehold, NJ (US)

Correspondence Address: WALL & TONG, LLP/;ALCATEL-LUCENT USA INC., 25 James Way, Eatontown, NJ, 07724, US

(21) Appl. No.: 12/415,064

(22) Filed: Mar. 31, 2009

(51) Int. Cl. B60P 1/00

(52) U.S. Cl. 414/467

(57) ABSTRACT

An apparatus and method for deploying a payload at a location are provided. The apparatus includes a mount adapted to be attached to a mobile unit while allowing normal operation of the mobile unit, and a deployment mechanism. The deployment mechanism supports a payload securing mode in which the deployment mechanism secures the payload to the mount and a payload deployment mode in which the deployment mechanism causes the payload to be ejected from the mount. The deployment mechanism is adapted to transition from the payload securing mode to the payload deployment mode in response to a control signal. The deployment mechanism includes a securing means adapted for securing the payload to the mount, an ejecting means adapted for ejecting the payload from the mount, and a breaking means adapted for breaking the securing means in response to a control signal, thereby causing the ejecting means to eject the payload from the mount.

### GOVERNMENT RIGHTS IN THE INVENTION

This invention was made with U.S. Government support under Contract No. N66001-04-C-8047, a DARPA contract. The U.S. Government has certain rights in this invention.

### FIELD OF THE INVENTION

The invention relates to the field of delivery of payloads to remote locations using mobile units and, more specifically, to ejection of payloads from mobile units.

### BACKGROUND OF THE INVENTION

There are many situations in which deployment of a payload to a remote location may be advantageous, e.g., in military operations, in civilian emergency situations, and the like. The deployment of a payload requires the payload to be fastened to a delivery source during transit and then released upon reaching the desired destination. One existing solution to deployment of a payload to a remote location includes use of magnets to fasten the payload to the delivery source and to release the payload from the delivery source at the desired location. Another existing solution to deployment of a payload to a remote location includes use of miniature motors or solenoids to control the release of the payload at the desired location. Disadvantageously, however, motor and solenoid based release mechanisms are susceptible to binding. Furthermore, since it is often desirable to use animals to deliver payloads to remote locations, these existing solutions are also disadvantageous in that they exceed the capabilities of most animals with respect to the weight that they can transport.

### SUMMARY OF THE INVENTION

Various deficiencies in the prior art are addressed through an apparatus and method for deploying a payload at a location. The apparatus includes a mount adapted to be attached to a mobile unit while allowing normal operation of the mobile unit, and a deployment mechanism. The deployment mechanism supports a payload securing mode in which the deployment mechanism secures the payload to the mount and a payload deployment mode in which the deployment mechanism causes the payload to be ejected from the mount. The deployment mechanism is adapted to transition from the payload securing mode to the payload deployment mode in response to a control signal. In one embodiment, the deployment mechanism includes a securing means adapted for securing the payload to the mount, an ejecting means adapted for ejecting the payload from the mount, and a breaking means adapted for breaking the securing means in response to a control signal, thereby causing the ejecting means to eject the payload from the mount.

### BRIEF DESCRIPTION OF THE DRAWINGS

The teachings of the present invention can be readily understood by considering the following detailed description in conjunction with the accompanying drawings, in which:

FIG. 1A depicts a high-level block diagram of a payload delivery mechanism secured to a mobile unit before a trigger causes ejection of a payload by the payload delivery mechanism;

FIG. 1B depicts a high-level block diagram of a payload delivery mechanism secured to a mobile unit after a trigger causes ejection of a payload by the payload delivery mechanism;

FIG. 2 depicts a high-level block diagram of a top view of one embodiment of the payload delivery mechanism of FIG. 1;

FIG. 3A depicts a high-level block diagram of a side view of one embodiment of the payload delivery mechanism of FIG. 1, where the payload is secured to the launching mount;

FIG. 3B depicts a high-level block diagram of a side view of one embodiment of the payload delivery mechanism of FIG. 1, where the payload is being ejected from the launching mount;

FIG. 4 depicts a high-level block diagram of a top view of one embodiment of the payload delivery mechanism that uses a spring-based ejection means in place of the elastic-based ejection means of FIGS. 1-3;

FIG. 5A depicts a high-level block diagram of a side view of one embodiment of the payload delivery mechanism of FIG. 4, where the payload is secured to the launching mount;

FIG. 5B depicts a high-level block diagram of a side view of one embodiment of the payload delivery mechanism of FIG. 4, where the payload is being ejected from the launching mount;

FIG. 6 depicts a high-level block diagram of one embodiment of a method for ejecting a payload from a launching mount; and

FIG. 7 depicts a high-level block diagram of a general-purpose computer suitable for use in performing functions described herein.

To facilitate understanding, identical reference numerals have been used, where possible, to designate identical elements that are common to the figures.

### DETAILED DESCRIPTION OF THE INVENTION

The present invention provides a light-weight, low-power, and robust release mechanism for deploying a payload at a remote location. Although primarily depicted and described with respect to a specific type of mobile unit and specific designs for a payload delivery mechanism, it will be appreciated that the principles of the present invention may be realized using various other designs for the payload delivery mechanism.

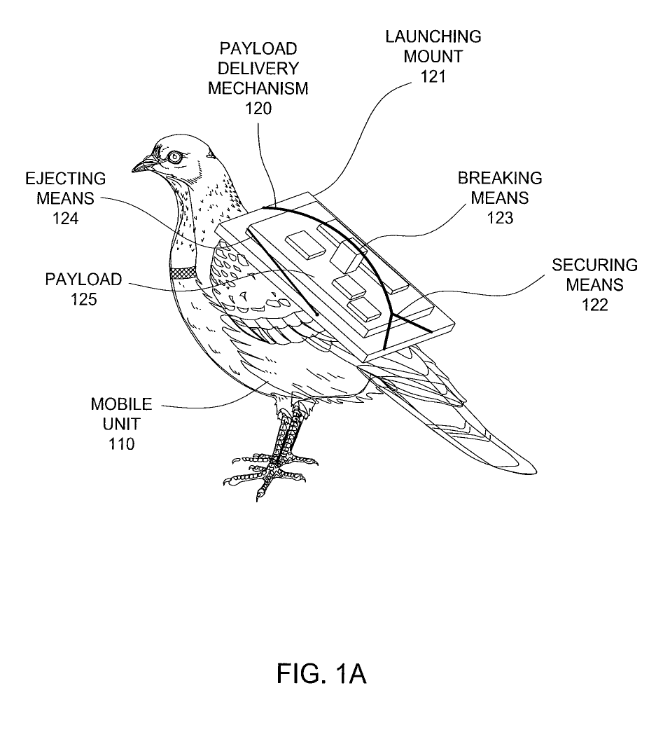

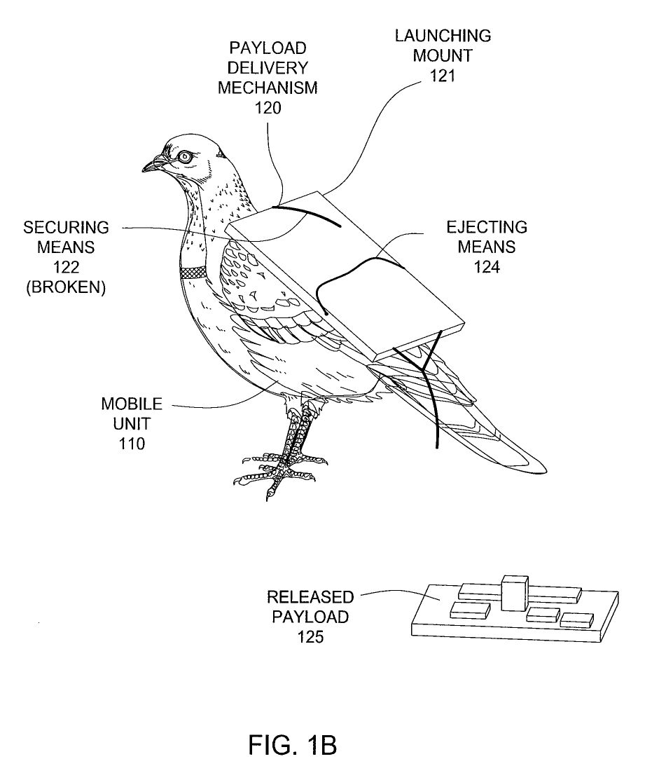

FIG. 1A depicts a high-level block diagram of a payload delivery mechanism secured to a mobile unit before a trigger causes ejection of a payload by the payload delivery mechanism. FIG. 1B depicts a high-level block diagram of a payload delivery mechanism secured to a mobile unit after a trigger causes ejection of a payload by the payload delivery mechanism.

Specifically, FIG. 1A and FIG. 1B depict a mobile unit 110 having a payload delivery mechanism secured 120 thereto. The payload delivery mechanism 120 includes a launching mount 121, a securing means 122, a breaking means 123, an ejecting means 124, and a payload 125.

As depicted in FIG. 1A, the securing means 122 secures payload 125 to the launching mount 121. The payload 125 remains secured to launching mount 121 until the mobile unit 110 reaches a desired location at which the payload 125 is to be deployed.

As depicted in FIG. 1B, a trigger causes the breaking means 123 to break the securing means 122, thereby causing ejecting means 124 to eject the payload 125 from launching mount 121. In this manner, the payload 125 is deployed at the desired location.

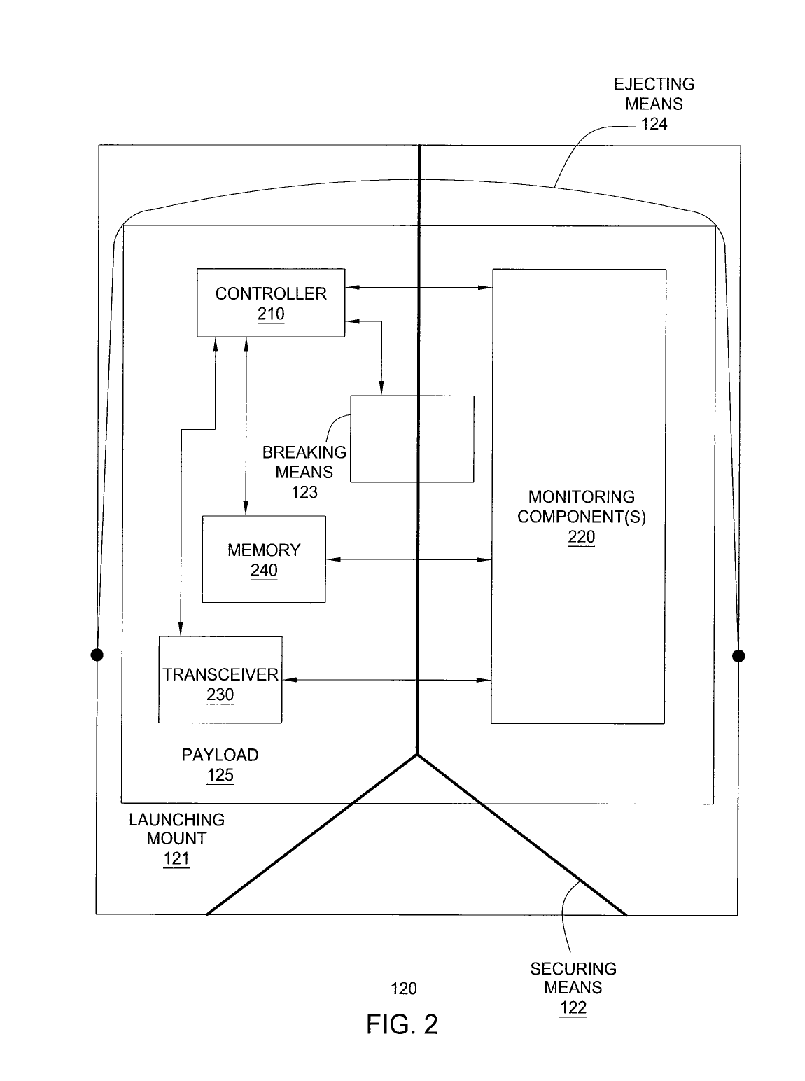

The operation of payload delivery mechanism 120 in ejecting payload 125 from launching mount 121 using a combination of securing means 122, breaking means 123, and ejecting means 124, and may be better understood with respect to FIG. 2.

The mobile unit 110 may be any mobile unit capable of operating as a delivery source. For example, mobile unit 110 may be an animal (e.g., a bird, a mouse, or any other suitable animal), an unmanned aerial vehicle, a roving robot, or any other suitable mobile unit.

The mobile unit 110 will often have a maximum carrying capacity and, thus, the payload delivery mechanism 120 often must be light-weight. The inventors have realized a light-weight, low power, and robust payload delivery mechanism suitable for use in conjunction with any mobile unit, but particular suited for use in conjunction with a miniature mobile unit having a maximum carrying capacity. For example, miniature mobile units, such as birds, mice, or other miniature mobile units cannot carry as much weight as other mobile units, such as unmanned aerial vehicles, roving robots, or other mobile units having greater carrying capacity. The use of such miniature mobile units may be advantageous in many situations, e.g., such as where rugged terrain must be traversed in order to deploy the payload 125 to a desired location (e.g., in remote mountainous regions, where massive destruction has resulted in huge mountains of rubble, and the like), where the payload 125 must be deployed to a desired location in a covert manner, as well as in various other situations.

The payload delivery mechanism 120 is adapted to be secured to the mobile unit 110 in any suitable manner.

The payload delivery mechanism 120 may be secured to the mobile unit 110 via the launching mount 121. For example, the payload delivery mechanism 120 may be secured to the mobile unit 110 using one or more straps attached to the launching mount 121 and wrapped around the mobile unit 110. For example, the payload delivery mechanism 120 may be secured to mobile unit 110 using a connector-port system, e.g., where a port on the mobile unit 110 is adapted to receive a connector affixed to the launching mount 121 (or vice versa). The payload delivery mechanism 120 may be secured to the mobile unit 110 in any other suitable manner.

The manner in which the payload delivery mechanism 120 may be secured to the mobile unit 110 may depend on the type of mobile unit to which payload delivery mechanism is to be secured. For example, where mobile unit 110 is an animal, the payload delivery mechanism 120 must be secured to the mobile unit 110 such that it does not hinder the ability of the animal to reach the desired location (e.g., by positioning mount 121 on the back of the animal and wrapping a strap around the body of the animal without restricting part of the animal used by the animal to move). For example, where mobile unit 110 is a mechanical device, the launching mount 121 may be soldered to the mechanical device. The manner in which the payload delivery mechanism 120 may be secured to the mobile unit 110 may vary according to the type of mobile unit to which payload delivery mechanism 120 is to be secured in other ways.

The payload delivery mechanism 120 may be secured to the mobile unit 110 in a manner allowing normal operation of the mobile unit 110.

In the example of FIG. 1, the mobile unit 110 is a bird, and the payload delivery mechanism 120 is attached to the bird such that it is at an angle to the plane of the surface onto which the payload 125 is to be deployed. It will be appreciated that, since the payload delivery mechanism 120 is capable of ejecting payload 125 from launching mount 121, this exemplary arrangement (i.e., in which the payload delivery mechanism 120 is attached to mobile unit 110 such that it is at an angle to the plane of the surface onto which payload 125 is to be deployed) is not required. The payload delivery mechanism 120 is capable of ejecting payload 125 from launching mount 121 regardless of the angle of the payload delivery mechanism 120 to the plane of the surface onto which payload 125 is to be deployed.

The payload 125 may include anything that may be delivered to a location and, thus, the mobile unit 110 may be used to deploy payload 125 for many different types of applications. For example, the payload 125 may be adapted for use in monitoring the location at which payload 125 is deployed and, thus, may include one or more monitoring components for collecting information from the location to which the payload 125 is delivered (e.g., a microphone, a camera, one or more sensors, and the like, as well as various combinations thereof). The payload 125 may be deployed for other purposes.

The payload 125 may be used for military operations. For example, the payload 125 may be deployed in enemy territory (e.g., to monitor troop movements), may be deployed to a location to monitor the location before initiating a strike against the location, and the like.

The payload 125 may be used in spy operations. For example, the payload 125 may be deployed at a location to monitor conversations by persons of interest, may be deployed at a location to monitor for the presence of chemical or biological agents, and the like, as well as various combinations thereof.

The payload 125 may be used in civilian emergency operations. For example, the payload 125 may be deployed at the site of an emergency in order to monitor environmental conditions of the emergency site to determine whether or not the environment is safe for rescue workers (e.g., temperature, air quality, presence of toxins, and the like). For example, the payload may be deployed at the site of an emergency in order to monitor for survivors to determine if rescue workers need to enter a certain area.

The payload 125 may be used in various other applications.

The mobile unit 110 transports the payload delivery mechanism 120, with the payload 125 secured to launching mount 121, to a location at which the payload 125 is to be deployed. The payload 125 is ejected from launching mount 121 of the payload delivery mechanism 120 at the desired location. The ejection of the payload 125 from launching mount 121 of the payload delivery mechanism 120 at the desired location may be better understood with respect to FIG. 2.

FIG. 2 depicts high-level block diagram of one embodiment of a payload delivery mechanism. Specifically, as depicted in FIG. 2, the payload delivery mechanism 120 includes launching mount 121, securing means 122, breaking means 123, ejecting means 124, and payload 125. As further depicted in FIG. 2, payload 125 may include additional components adapted for performing functions described herein (illustratively, a controller 210 in communication with a monitoring component(s) 220, a transceiver 230, and a memory 240).

The securing means 122 secures the payload 125 to launching mount 121. The securing means 122 applies force to the payload 125 to secure the payload 125 to launching mount 121. The force applied by securing means 122 counteracts a force applied to the payload 125 by ejecting means 124, such that the payload remains stationary on the launching mount 121 until the breaking means 123 is triggered to break the securing means 122.

The securing means 122 is formed from a material that is strong enough to secure payload 125 to the launching mount 121, but which may be easily broken by breaking means 123 when the mobile unit 110 has reached the desired destination. The securing means 122 may be formed from a material having a structural integrity that may be easily altered, e.g., through heat or some other means of altering structural integrity. For example, the securing means may be formed from plastic, fishing line, or any other material strong enough to secure payload 125 to launching mount 125, but which may be easily broken by breaking means 123 when the mobile unit 110 has reached the desired location.

The securing means 122 is aligned such that it is adjacent to breaking means 123 (i.e., such that securing means 122 may be broken by breaking means 123 in response to a trigger). In one embodiment, the securing means 122 may be aligned such that at least some portion of securing means is touching the breaking means 123. In one embodiment, for example, where breaking means 123 is connected to payload 125, the securing means 122 may be positioned on top of the breaking means 123 (e.g., securing means 122 rests on top of the breaking means 123) such that the breaking means 123 can break the securing means 122 in response to a trigger.

In the exemplary embodiment of FIG. 2, the securing means 122 is implemented as a thin strip of material secured to launching mount 121 at three points of attachment. The first point of attachment is on a side of launching mount 121 towards which ejecting means 124 is applied to a side of payload 125 (i.e., a side of launching mount 121 that is opposite a direction in which the ejecting means 124 applies force to the payload 125). The second and third points of attachment are on a side of the launching mount 121 that is opposite the side of the launching mount 121 of the first point of attachment. In this manner, the securing means 122 forms an inverted “Y”. The securing means 122 is aligned over breaking means 123. It will be appreciated that the material, shape, size, and other properties of the securing means 122 may be different than depicted in FIG. 2, as long as the securing means is capable of securing payload 125 to launching mount 121 until the breaking means 123 is triggered to break the securing means 122.

The breaking means 123 breaks securing means 122. The breaking means 123 breaks the securing means 122 in response to a trigger. The breaking of securing means 122 eliminates or reduces the force applied to the payload 125 by the securing means 122, thereby causing the force applied to the payload 125 by the ejecting means 124 to eject the payload 125 from the launching mount 121.

The breaking means 123 may be configured to break the securing means 122 in one or more locations.

The breaking means 123 is adapted for reducing the structural integrity of at least a portion of securing means 122.

In one embodiment, the breaking means 123 is a heating means, which applies heat to securing means 122, thereby weakening the structural integrity of securing means 122, which causes the securing means 122 to break. The amount of heat required to reduce the structural integrity of the securing means 122 will depend on the implementation of the securing means (e.g., type of material used, thickness of material used, and like factors, as well as various combinations thereof). As such, the heating means 123 may be implemented as any means suitable for heating at least a portion of the securing means 122 to sufficiently reduce the structural integrity of the securing means 122.

In one embodiment, for example, the heating means is a resistor. In this embodiment, electrical current is applied to the resistor, causing the resistor to heat up. The electrical current may be supplied to the resistor in any suitable manner. As an example, where the resistor is placed on payload 125, the electrical current required to heat the resistor may be supplied by one or more components on payload 125. As another example, where the resistor is not placed on payload 125, electrical current required to heat the resistor may be supplied by one or more components on launching mount 121. The electrical current may be supplied to the resistor from any suitable source (e.g., from a battery or any other component capable of providing the required amount of current).

The heat of the resistor reduces the structural integrity of securing means 122 until the securing means 122 breaks, thereby causing ejecting means 124 to eject the payload 125 from launching mount 121. The amount of heat that must be generated by the resistor to sufficiently reduce the structural integrity of the securing means 122 will depend on the characteristics of securing means 122. It will be appreciated that different combinations of resistance and current may be utilized to generate an amount of heat sufficient to reduce the structural integrity of the securing means 122 until the securing means 122 breaks. The condition(s) under which structural integrity of a material is reduced is sometimes referred to as the VICAT point or VICAT softening point of the material.

The heating means may be any other means of generating heat to be applied to the securing means 122 for breaking securing means 122. For example, the heating means may be a nichrome wire actuator having current supplied thereto, one or more incendiary devices, and the like, as well as various combinations thereof.

In the exemplary embodiment of FIG. 2, the breaking means 123 is implemented as a resistor attached to payload 125. The resistor is aligned near the center of payload 125, such that the securing means 122 may be aligned over the resistor. The resistor is used to break the securing means 122 by applying an electrical current to the resistor such that it heats up to a temperature sufficient to break securing means 122. As depicted in FIG. 2, the electrical current is supplied to the resistor from controller 210; however, it will be appreciated that the electrical current may be supplied to the resistor from any suitable source (e.g., controller 210 may signal a battery in a manner causing the battery to supply the required amount of current to the resistor). The heat of the resistor reduces the structural integrity of securing means 122 such that securing means 122 breaks, thereby causing ejecting means 124 to eject the payload 125 from launching mount 121. It will be appreciated that the type, location, and other properties of breaking means 123 may be different than depicted in FIG. 2, as long as breaking means 123 is aligned with respect to the securing means 122 in a manner enabling breaking means 123 to break securing means 122 in response to a trigger.

With respect to implementation of securing means 122 and breaking means 123, it will be appreciated that the implementations of securing means 122 and breaking means 123 are interdependent. The implementations of securing means 122 and breaking means 123 are inter-dependent at least because the amount of heat that must be generated by breaking means 123 in order to reduce the structural integrity of securing means 122 will depend on characteristics of securing means 122 (e.g., type of material, dimensions of the material, and like characteristics) and, similarly, the amount of heat that can be released by the breaking means 123 will depend on characteristics of breaking means 123 (e.g., such as, where a resistor is used, the resistance of the resistor and the amount of current supplied to the resistor).

In one embodiment, for example, the securing means 122 may be implemented as a strip of polyester fiber base plastic (e.g., such as the type often used in bundling shipping packages) having approximate dimensions of 0.03″×0.02″. In this example, the breaking means 123 must generate an amount of heat that is sufficient to reach the VICAT softening point of a strip of polyester fiber base plastic that has approximate dimensions of 0.03″×0.02″. For example, the VICAT softening point, at which structural integrity of the strip of polyester fiber base plastic is reduced enough to cause the strip of polyester fiber base plastic to break, may be reached by implementing the breaking means 123 as an 8 ohm resistor having approximately 450 mA of current supplied thereto.

In one embodiment, for example, the securing means 122 may be implemented as a strip of monofilament fishing line (e.g., 6 lb test) having an approximate diameter of 0.009″. In this example, the breaking means 123 must generate an amount of heat that is sufficient to reach the VICAT softening point of a strip of 6 lb test monofilament fishing line that has an approximate diameter of 0.009″. For example, the VICAT softening point, at which structural integrity of the strip of monofilament fishing line is reduced enough to cause the strip of monofilament fishing line to break, may be reached by implementing the breaking means 123 as a 14 ohm resistor having approximately 260 mA of current supplied thereto.

With respect to implementation of the securing means 122 and the breaking means 123, it will be appreciated that the above-described examples represent just a few of the many different implementations (e.g., in terms of type of material, dimensions of material, type of breaking means, and the like) which may be utilized to provide the payload delivery mechanism depicted and described herein. For example, where a thicker strip of polyester fiber base plastic is used as securing means 122, a larger resistor and/or additional current may be required to break the strip of polyester fiber base plastic. For example, where a different type of material is used as securing means 122, different resistance/current combinations may be used to break the material.

The ejecting means 124 ejects the payload 125 from the launching mount 121. The ejecting means 124 ejects the payload from the launching mount 121 using a force applied to the payload 125 by the ejecting means 124. Before the breaking means 123 is triggered to break the securing means 122, the force applied to payload 125 by the ejecting means 124 is counteracted by the securing means 122 (i.e., the securing means 122 keeps payload 125 secured to the launching mount 121 despite the force applied to the payload 125 by ejecting means 124). After the breaking means 123 is triggered to break the securing means 122, the force applied to the payload 125 by the ejecting means 124 is no longer counteracted by the securing means 122, thereby causing the force applied to the payload 125 by the ejecting means 124 to eject the payload 125 from the launching mount 121. In this manner, payload 125 is deployed at the desired location.

In the exemplary embodiment of FIG. 2, ejecting means 124 is an elastic band. The ejecting means 124 may be implemented in any manner suitable for ejecting payload 125 from launching mount 121.

The ejecting means is attached to launching mount 121 and stretched to fit around a portion of payload 125 for applying an ejecting force to payload 125.

The ejecting means 124 may be attached to the launching mount 121 in any suitable manner. In one embodiment, two ends of ejecting means 124 are attached to the launching mount 121 on two opposing sides of launching mount 121, respectively. In one embodiment, for example, the two ends of the elastic band are attached to the sides of the launching mount 121. This is depicted in FIG. 2. In another embodiment, for example, the two ends of the elastic band are attached to opposite sides of the surface of launching mount 121 on which payload 125 is secured. The two ends of the elastic band may be attached to the launching mount in any other manner suitable for applying an ejecting force to payload 125.

The ejecting means 124 is stretched over the side of payload 125 to which an ejecting force is to be applied (i.e., ejecting means 124 is stretched in a direction that is opposite the direction in which the payload 125 is to be ejected from the launching mount 121). In the exemplary embodiment of FIG. 2, for example, the elastic band is stretched toward the side of the launching mount 121 at which the first point of attachment of securing means 122 is made. The payload 125 is secured to launching mount 121 by securing means 122 (before the breaking means 123 breaks the securing means 122), such that the stretching of the elastic band around payload 125 does not initially cause the payload 125 to be ejected from launching mount 121. The stretching of the ejecting means 124 to fit around the side of the payload 125 to which an ejecting force is to be applied creates potential energy, which is used to eject payload 125 from launching mount 121 after breaking means 123 breaks the securing means 122. In other words, the elastic band applies the ejecting force to the side of the payload 125 opposite the direction in which the payload 125 is to be ejected from the launching mount 121.

With respect to ejecting means 124, it will be appreciated that both the direction in which the ejecting means 124 is stretched to be applied to payload 125 and the direction in which the ejecting force is applied to payload 125 depend on the attachment of the ejecting means 124 to launching mount 121 and securing of the payload 125 to launching mount 121. Thus, the ejecting force applied by ejecting means 124 may be designed to be applied to the payload 125 in any direction, thereby enabling controlled ejection of the payload 125 from launching mount 121.

The ejecting means 124 may be any suitable elastic material. The ejecting means 124 may have any suitable characteristics (e.g., length, shape, thickness, elasticity, and the like), which may depend on factors such as the points of attachment of the ends of ejecting means 124 to launching mount 121, the size of payload 125, and like factors. In other words, it will be appreciated that the characteristics of ejecting means 124 may be different than depicted in FIG. 2, as long as the ejecting means is capable of ejecting the payload 125 from the launching mount 121 after the breaking means 123 breaks the securing means 122.

As described herein, in response to a trigger, the breaking means 123 is activated, such that the breaking means 123 breaks the securing means 122, thereby causing the ejecting means 124 to eject the payload 125 from the launching mount 121.

In one embodiment, the trigger is a payload release control signal provided by a controller 210 on payload 125.

In one embodiment, controller 210 provides the payload release control signal to breaking means 123 directly. For example, where breaking means 123 is a resistor, controller 210 may provide the payload release control signal as an electrical current which causes the resistor to heat such that it breaks the securing means 122.

In one embodiment, controller 210 provides the payload release control signal to one or more other components of payload 125 adapted for causing the breaking means 123 to break securing means 122. For example, where breaking means 123 is a resistor, controller 210 may provide the payload release control signal to an electrical power source (omitted for purposes of clarity), thereby triggering the power source to supply an electrical current to the resistor, which causes the resistor to heat such that it breaks the securing means 122.

The controller 210 may initiate the payload release control signal for causing the breaking means 123 to break securing means 122 in other ways. In other embodiments, the payload release control signal may originate from a component or components other than controller 210 (e.g., from one or more other components on the payload 125, from one or more components on launching mount 121, and the like, as well as various combinations thereof).

In such embodiments, the payload release control signal may be generated in response to one or more local conditions detected at payload delivery mechanism 120 and/or in response to a remote control signal that is received at payload delivery mechanism 120.

In one embodiment, the payload release control signal is generated in response to a condition associated with a timer included on the payload 125 (omitted for purposes of clarity). For example, where it is expected that the mobile unit 110 will reach a desired location within a certain amount of time, a timer on payload 125 may be set such that the payload release control signal is generated by controller 210 when the mobile unit 110 is expected to be at the desired location.

In one embodiment, the payload release control signal is generated in response to a condition associated with a location tracking capability included on payload 125. For example, payload 125 may support a Global Positioning System (GPS) capability such that the control signal is initiated by controller 210 when the GPS capability detects that the mobile unit 110 has reached a desired location.

The payload release control signal may be generated in response to various other local conditions detected at payload delivery mechanism 120. For example, the payload release control signal may be generated by the controller 210 in response to detecting an environmental condition using one or more sensors included on the payload 125 (e.g., in response to detecting a temperature, a chemical, and the like), in response to detecting a particular time of day, and the like, as well as various combinations thereof.

In one embodiment, the payload release control signal is generated in response to a remote control signal received at payload delivery mechanism 120. The remote control signal may be initiated in response to different conditions. The remote control signal may be received from different sources.

In one embodiment, for example, the remote control signal may be initiated manually by a user who is monitoring the location of the mobile unit 110 (e.g., by visually monitoring the location of the mobile unit 110, by using some location monitoring device where the location of the mobile unit 110 is out of range of visual monitoring of the user, and the like).

In one embodiment, for example, the remote control signal may be initiated automatically, e.g., using a timer, a location tracking capability (e.g. remote GPS tracking capability), and the like, as well as various combinations thereof.

The remote control signal may be communicated in any format. For example, remote control signal may be communicated as a simple on-off signal adapted for triggering breaking means 123, as a control packet or message including information adapted for use in triggering the breaking means 123, and the like.

The remote control signal may be communicated to the payload 125 in any manner (e.g., using a radio signal, an optical signal, an acoustic signal, and like suitable signal types, as well as various combinations thereof).

In such embodiments, the payload 125 includes means for receiving such remote control signals. For example, the payload 125 may include a receiver adapted for receiving radio signals. For example, the payload 125 may include an optical detector for receiving optical signals. This capability of the payload 125 to receive remote control signals in different formats may be represented by transceiver 230 implemented on the payload 125 (although other types of components may be included on payload 125 for receiving such remote control signals).

In one embodiment, the receiving means of payload 125 (e.g., the transceiver 230) provides the remote control signal to controller 210. The controller 210 may then generate the payload release control signal in response thereto, or may use control information included in the remote control signal to generate the payload release control signal at a later time. In another embodiment, the receiving means of payload 125 (e.g., transceiver 230) provides the remote control signal to breaking means 123 directly. The remote control signal may be used to trigger the breaking means 123 in other ways.

As depicted in FIG. 2, the controller 210 also may cooperate with other components on payload 125 to provide other functions.

The payload 125 includes monitoring component(s) 220. For example, monitoring component(s) 220 may include a microphone, a camera, one or more sensors (e.g., a temperature sensor, a chemical sensor, a biological sensor, a nuclear sensor, or any other sensors which may be deployed on payload 125), and the like, as well as various combinations thereof. The payload 125 may include means for providing information collected by monitoring component(s) 220 to one or more remote devices (illustratively, transceiver 230). The transceiver 230 may be adapted to transmit collected information to one or more remote devices. For example, transceiver 230 may transmit collected information to a control device, a management system, and the like. The remote devices may be adapted for receiving, and storing and/or presenting, information received from payload 125 after it has been deployed to a desired location. This enables remote monitoring of information that is being collected by payload 125 after it has been deployed to a desired location.

The payload 125 may include means for storing information collected by monitoring component(s) 220 (illustratively, memory 240).

The payload 125 may include means for processing the collected information locally. The information processing means may be capable of providing any type of information processing. For example, the information processing means may be capable of performing voice recognition on voices captures via the microphone. For example, the information processing means may be capable of processing sensor data to generate summaries of the sensor data in order to reduce the volume of sensor data that must be transmitted by transceiver 230 and/or stored by memory 240. The information processing means may be capable of performing any other processing that may be required.

The information processing capabilities may be provided by payload 125 in many ways. For example, the controller 210 may include some information processing capabilities (e.g., for processing information collected by monitoring component(s) 220 before the information is stored locally in memory 240 and/or transmitted remotely by transceiver 230). For example, information processing capabilities may be provided on payload 125 by one or more components other that controller 210 (e.g., by providing one or more other controllers dedicated for processing collected information).

The payload 125 may include other information collection, processing, transmission and/or storage capabilities.

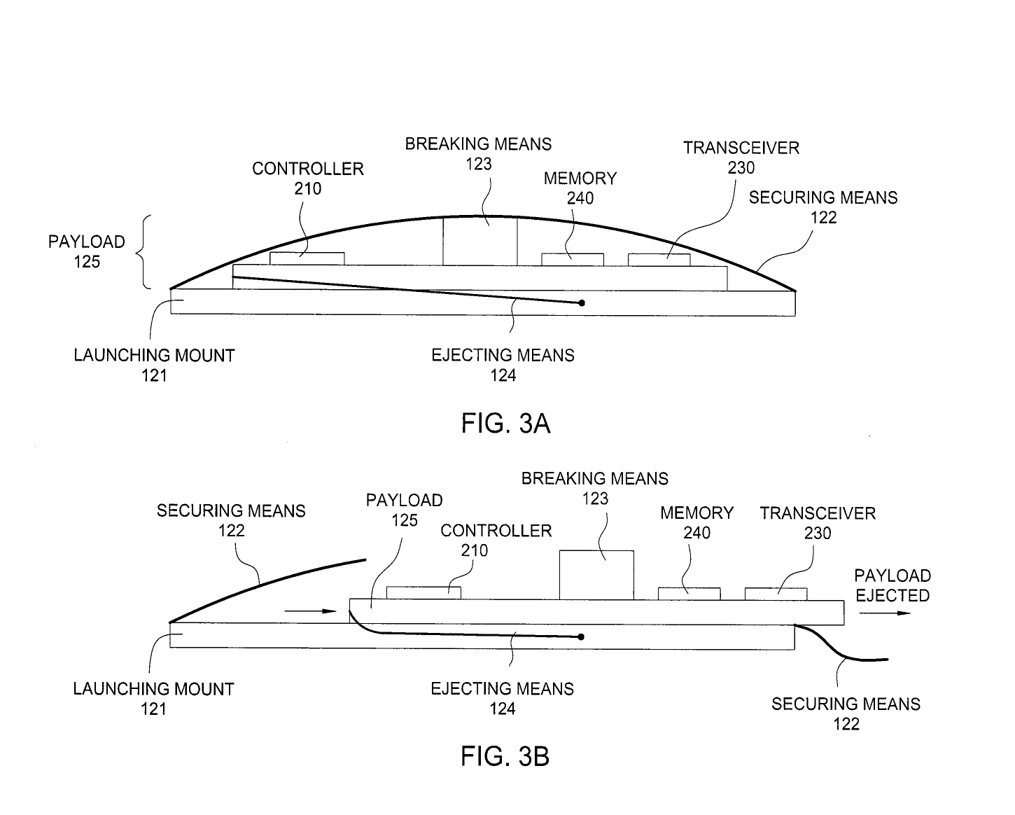

FIG. 3A depicts a high-level block diagram of a side view of one embodiment of the payload delivery mechanism of FIG. 1, where the payload is secured to the launching mount. As depicted in FIG. 3A, securing means 122 applies a securing force against the payload 125 at multiple points (e.g., on both ends of payload 125, as well as on breaking means 123 of payload 125). The ejecting means 124 applies an ejecting force against the payload 125. The securing force counters the ejecting force such that the payload 125 remains stationary on the launching mount 121.

FIG. 3B depicts high-level block diagram of a side view of one embodiment of the payload delivery mechanism of FIG. 1, where the payload is being ejected from the launching mount. As depicted in FIG. 3B, securing means 122 has been broken, thereby removing the securing force previously applied by securing means 122 against the payload 125. As a result, the ejecting force applied to payload 125 by ejecting means 124 causes the payload to be ejected off of launching mount 121 (illustratively, in a direction from left to right).

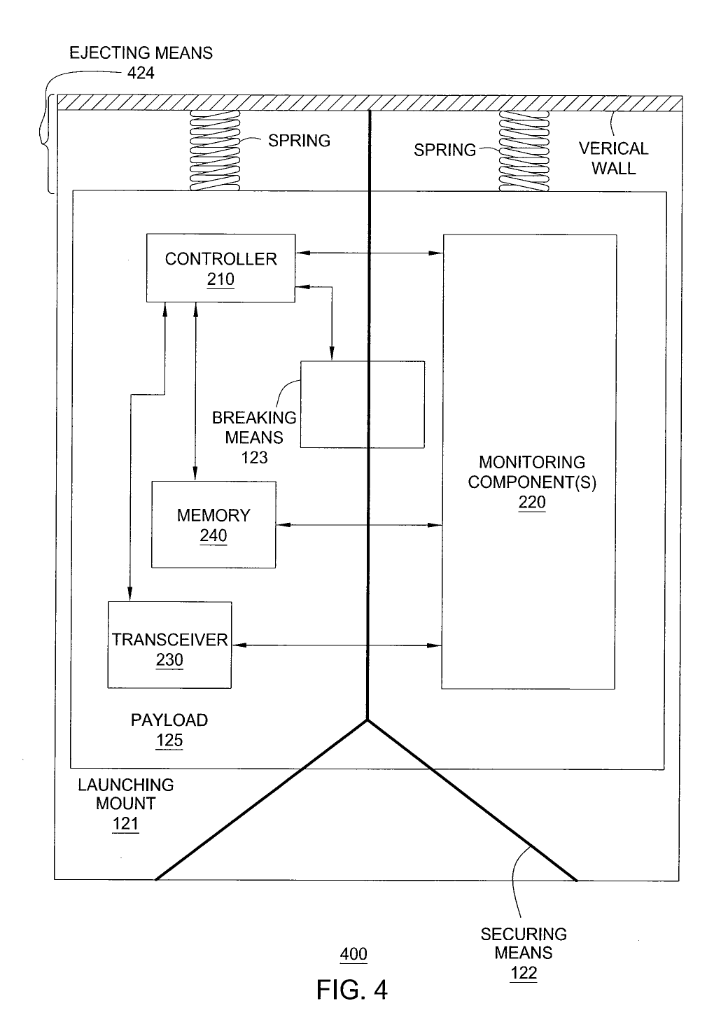

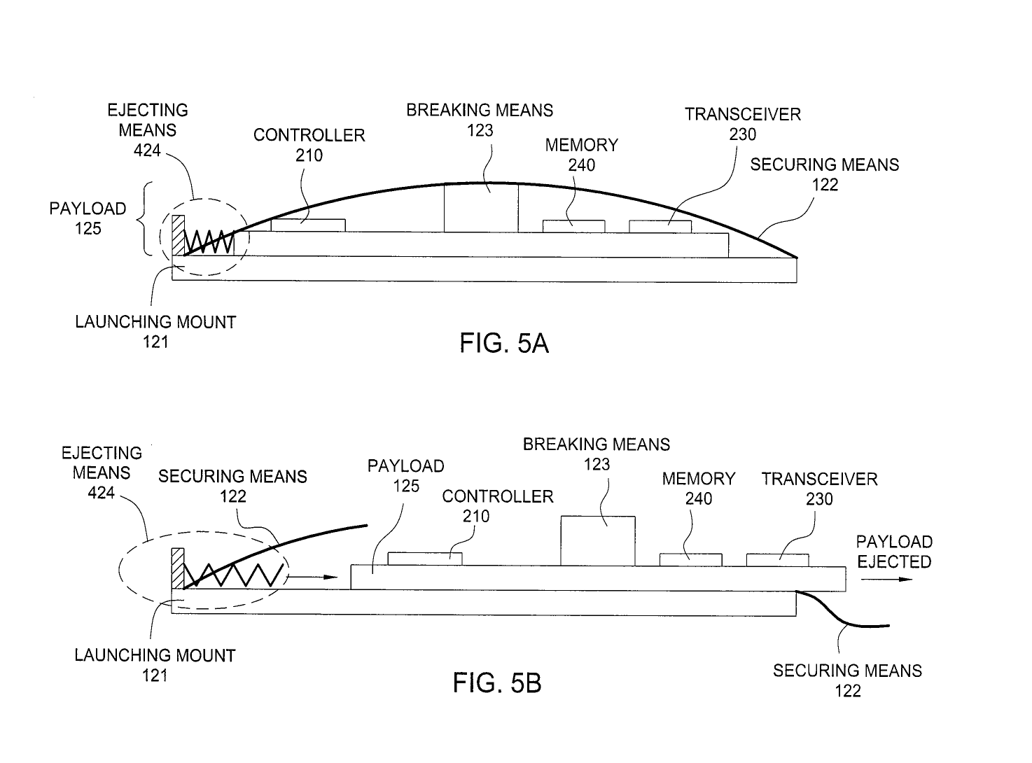

As described hereinabove, the ejecting means that is used for ejecting the payload from the launching mount may be implemented in a number of ways. In one embodiment, as depicted and described hereinabove with respect to FIGS. 1-3, the ejecting means may be an elastic band (depicted as ejecting means 124). In another embodiment, the ejecting means may be implemented using one or more springs, which embodiment is depicted and described herein with respect to FIGS. 4-5.

FIG. 4 depicts a high-level block diagram of a top view of one embodiment of the payload delivery mechanism that uses a spring-based ejection means in place of the elastic-based ejection means of FIG. 1-3. The payload delivery mechanism 400 of FIG. 4 operates in a manner similar to the payload delivery mechanism 120 depicted and described with respect to FIG. 1-FIG. 3, with the exception that the ejecting means 124 (which is an elastic-based ejecting means) is replaced by an ejecting means 424 (which is a spring-based ejecting means).

As depicted in FIG. 4, the ejecting means 424 includes a vertical wall having a pair of springs coupled thereto.

The vertical wall is located at or near an edge of the launching mount 121 that is opposite the direction in which the payload 125 is to be ejected from launching mount 121. In the exemplary embodiment of FIG. 4, the vertical wall is located toward the edge of the launching mount 121 at which the first point of attachment of securing means 122 is made. The vertical wall is substantially normal to the surface of launching mount 121 to which payload 125 is secured.

The vertical wall has a pair of springs coupled thereto. The springs are coupled to one side of the vertical wall that is facing the payload 125. The springs are compressed between the vertical wall and one of the sides of launching mount 121 (i.e., one of the sides of launching mount 121 that is normal to the surfaces of the launching mount 121). The payload 125 is secured to launching mount 121 by securing means 122 (before the breaking means 123 breaks the securing means 122), such that the compression of the springs does not initially cause the payload 125 to be ejected from launching mount 121. The compression of the springs in this manner creates potential energy, which is used to eject payload 125 from launching mount 121 after the breaking means 123 breaks the securing means 122. In other words, the springs apply the ejecting force to the side of the payload 125 opposite the direction in which the payload 125 is to be ejected from the launching mount 121.

The vertical wall provides a support for the pair of springs, such that, when the breaking means 123 breaks the securing means 122, the ejecting force exerted by the pair of springs against payload 125 as the springs are expanding is countered by the vertical wall to enable the payload 125 to be ejected from the launching mount (i.e., the vertical wall remains rigid such that the potential energy of the springs is applied to the payload 125 to eject the payload 125 from launching mount 121).

With respect to ejecting means 424, it will be appreciated that both the direction in which the ejecting means 424 is compressed to be applied to payload 125 and the direction in which the ejecting force is applied to payload 125 depend on the attachment of the ejecting means 424 to launching mount 121 and securing of the payload 125 to launching mount 121. Thus, the ejecting force applied by ejecting means 424 may be designed to be applied to the payload 125 in many different directions, thereby enabling control of the direction in which the payload 125 is ejected from launching mount 121.

The ejecting means 424 may include any suitable material for the vertical wall and any suitable types of springs. The vertical wall may be coupled to launching mount 121 in any suitable manner. For example, the vertical wall may be formed as part of launching mount 121 (e.g., one piece of material) or may be affixed to launching mount 121 in any suitable manner. The springs may be affixed to the vertical wall in any suitable manner. The springs may have any suitable characteristics (e.g., material, size, rate, and the like), which may depend on factors such as the point of attachment of the vertical wall to launching mount 121, the size of payload 125, and like factors. In other words, it will be appreciated that the characteristics of ejecting means 424 may be different than depicted in FIG. 4, as long as the ejecting means is capable of ejecting the payload 125 from the launching mount 121 after the breaking means 123 breaks the securing means 122.

Although depicted and described with respect to using one vertical wall, multiple vertical walls may be used to support multiple springs. Although depicted and described with respect to using two springs, fewer or more springs may be used to provide an ejecting force for ejecting payload 125 from launching mount 121. Thus, it will be appreciated that ejecting means 424 may be implemented in other ways while providing the ejecting force for ejecting payload 125 from launching mount 121.

As described herein, in response to a trigger, the breaking means 123 is activated, such that the breaking means 123 breaks the securing means 122, thereby causing the ejecting means 424 to eject the payload 125 from the launching mount 121. This is depicted and described herein with respect to ejecting means 124 of FIG. 1-FIG. 3, and the principles are similar for use of ejecting means 424 to eject the payload 125 from the launching mount 121.

FIG. 5A depicts a high-level block diagram of a side view of one embodiment of the payload delivery mechanism of FIG. 4, where the payload is secured to the launching mount. As depicted in FIG. 5A, securing means 122 applies a securing force against the payload 125 at multiple points (e.g., on both ends of payload 125, as well as on breaking means 123 of payload 125). The ejecting means 424 applies an ejecting force against the payload 125. The securing force counters the ejecting force such that the payload 125 remains stationary on the launching mount 121.

FIG. 5B depicts high-level block diagram of a side view of one embodiment of the payload delivery mechanism of FIG. 4, where the payload is being ejected from the launching mount. As depicted in FIG. 5B, securing means 122 has been broken, thereby removing the securing force previously applied by securing means 122 against the payload 125. As a result, the ejecting force applied to payload 125 by ejecting means 424 causes the payload to be ejected off of launching mount 121 (illustratively, in a direction from left to right).

Although primarily depicted and described herein with respect to embodiments in which the breaking means 123 is implemented as a single component (e.g., using a single resistor having current supplied thereto), in other embodiments the breaking means 123 may be implemented using multiple components (e.g., using multiple resistors, using one or more resistors and nichrome wire, and the like, as well as various combinations thereof).

Although depicted and described herein with respect to embodiments in which the securing force is applied to the top of the breaking means 123, in other embodiments the securing means 122 may not apply the securing force to the top of breaking means 123. In such embodiments, the breaking means 123 may be arranged to be adjacent to securing means 122 (e.g., securing means 122 passes on either size of breaking means 123) such that it may break securing means 122 in response to a control signal.

Although depicted and described herein with respect to embodiments in which the elastic ejecting means 124 is implemented as a single elastic band, in other embodiments the elastic ejecting means 124 may utilize multiple elastic bands. Similarly, although depicted and described herein with respect to embodiments in which spring ejecting means 324 is implemented as a pair of springs, in other embodiments the spring ejecting means 324 may utilize less or more springs.

Although depicted and described herein with respect to embodiments in which the ejecting means is implemented using an elastic band (ejecting means 124) or springs (ejecting means 324), in other embodiments the ejecting means may be implemented using other suitable means for ejecting the payload from the launching mount after the breaking means breaks the securing means.

The payload delivery mechanism may be modified in other ways while still providing the payload release capabilities and its associated advantages.

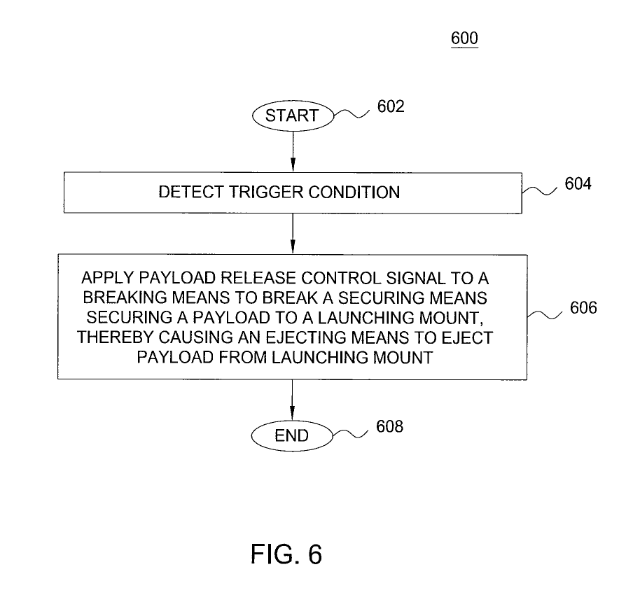

FIG. 6 depicts a method according to one embodiment of the present invention. Specifically, method 600 of FIG. 6 includes a method for ejecting a payload from a launching mount. The method 600 begins at step 602 and proceeds to step 604. At step 604, a trigger condition is detected. At step 606, a payload release control signal is applied to a breaking means to break a securing means that is securing the payload to the launching mount using a first force, thereby causing a second force that is applied to the payload by an ejecting means to eject the payload from the launching mount. At step 608, method 600 ends.

The functions depicted and described herein as being performed by the securing means and the breaking means may be performed by a deployment mechanism, which may be implemented using a combination of the securing means and breaking means depicted and described herein and/or using other mechanisms for providing the payload deployment functions depicted and described herein. The deployment mechanism may be considered to have two modes of operation: a payload securing mode (in which the deployment mechanism secures the payload to the mount), and a payload deployment mode (in which the deployment mechanism causes the payload to be ejected from the mount). The deployment mechanism is adapted to transition from the payload securing mode to the payload deployment mode in response to one or more control signals.

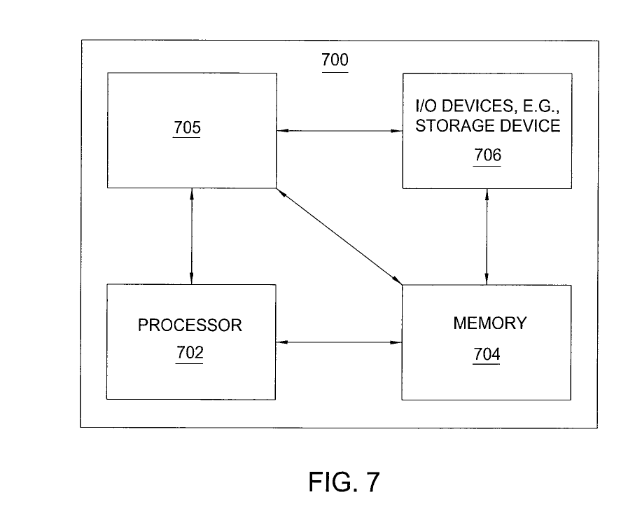

FIG. 7 depicts a high-level block diagram of a general-purpose computer suitable for use in performing the functions described herein. As depicted in FIG. 7, system 700 comprises a processor element 702 (e.g., a CPU), a memory 704, e.g., random access memory (RAM) and/or read only memory (ROM), a payload release control module 705, and input/output devices 706 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)). The types of components included in system 700 depend on where system 700 is implemented.

The system 700 may be implemented as part of a payload (e.g., where controller 210, monitoring components 220, transceiver 230, memory 240, and/or other components cooperate to operate in a manner similar to that of system 700). In such an embodiment, the components included in system 700 may include a subset of the components described with respect to system 700 (e.g., the keyboard, keypad, mouse, and the like components would probably not be used) and/or may include other types of components not described with respect to system 700 (e.g., GPS modules, sensors, and the like).

The system 700 may be implemented as a system for controlling release of a payload remotely. For example, the general-purpose computer described with respect to FIG. 7 may be used for providing a remote control signal which triggers ejection of a payload. For example, the general-purpose computer described with respect to FIG. 7 may be used for providing a remote control signal which triggers ejection of a payload may be used for receiving, processing, storing and/or presenting information collected by a payload after the payload is deployed. In such embodiments, system 700 be implemented as or form part of a laptop, personal data assistant (PDA), or any other device suitable for providing such functions.

The general-purpose computer described with respect to FIG. 7 may be used for providing other functions described herein.

It should be noted that the present invention may be implemented in software and/or in a combination of software, firmware, hardware, and the like, as well as various combinations thereof, e.g., using application specific integrated circuits (ASIC), a field programmable gate array (FPGA), a general purpose computer, or any other hardware equivalents. In one embodiment, the payload release control process 705 can be loaded into memory 704 and executed by processor 702 to implement the functions as discussed above. As such, payload release control process 705 (including associated data structures) of the present invention can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus for deploying a payload, comprising:
a mount adapted to be attached to a mobile unit while allowing normal operation of the mobile unit; and
a deployment mechanism supporting a payload securing mode in which the deployment mechanism secures the payload to the mount and a payload deployment mode in which the deployment mechanism causes the payload to be ejected from the mount;
wherein the deployment mechanism is adapted to transition from the payload securing mode to the payload deployment mode in response to a control signal.

2. The apparatus of claim 1, wherein the deployment mechanism comprises:
an ejecting means coupled to the mount, the ejecting means adapted for ejecting the payload from the mount using an ejecting force applied to the payload;
a securing means coupled to the mount, the securing means adapted for securing the payload to the mount using a securing force applied to the payload, wherein the securing force prevents the ejecting force from ejecting the payload from the mount prior to a control signal being detected; and
a breaking means adapted for breaking the securing means in response to the control signal, thereby causing the ejecting force of the ejecting means to eject the payload from the mount.

3. The apparatus of claim 1, wherein the deployment mechanism comprises:
a securing means coupled to the mount, the securing means adapted for securing the payload to the mount using a securing force applied to the payload.

4. The apparatus of claim 3, wherein the securing means is attached to the mount at three or more points of attachment.

5. The apparatus of claim 3, wherein the securing means is formed from a material having a structural integrity which may be weakened by the breaking means.

6. The apparatus of claim 1, wherein the deployment mechanism comprises:
an ejecting means coupled to the mount, the ejecting means adapted for ejecting the payload from the mount using an ejecting force applied to the payload.

7. The apparatus of claim 6, wherein the ejecting means is adapted to apply the ejecting force to the payload in a desired direction in which the payload is to be ejected from the mount.

8. The apparatus of claim 6, wherein the ejecting means comprises one of an elastic band and at least one spring.

9. The apparatus of claim 8, wherein the elastic band comprises a first end attached to a first side of the mount and a second end attached to a second side of the mount, wherein the elastic band is stretched to fit around a side of the payload such that the ejecting force is applied to the payload.

10. The apparatus of claim 8, wherein each of the at least one spring is coupled to a wall, wherein the wall is coupled to the mount, wherein the wall is normal to the mount, wherein each of the at least one spring is compressed between the vertical wall and a side of the payload such that the ejecting force is applied to the payload.

11. The apparatus of claim 1, wherein the deployment mechanism comprises:
a breaking means adapted for breaking the securing means in response to the control signal, thereby causing the ejecting means to eject the payload from the mount.

12. The apparatus of claim 11, wherein the breaking means is adapted for weakening the structural integrity of at least a portion of the securing means.

13. The apparatus of claim 11, wherein the breaking means comprises a heating means adapted for heating at least a portion of the securing means.

14. The apparatus of claim 13, wherein the heating means comprises at least one resistor having current supplied thereto.

15. The apparatus of claim 14, wherein the at least one resistor is coupled to the payload, wherein the payload comprises a controller adapted for causing the current to be supplied to the at least one resistor.

16. The apparatus of claim 15, wherein the securing and ejecting forces are balanced before the control signal is generated and the ejecting force is greater than the securing force after the control signal is generated.

17. The apparatus of claim 1, wherein the control signal is generated in response to at least one of a local condition and a remote signal received from a remote source.

18. The apparatus of claim 17, wherein the local condition is detected using at least one of a timer, a location tracking capability, and a sensor.

19. The apparatus of claim 17, wherein the remote signal comprises one of a radio signal, an optical signal, and an acoustic signal.

20. The apparatus of claim 1, wherein the payload comprises:
a control means adapted for providing the control signal for triggering the deployment mechanism to transition from the payload securing mode to the payload deployment mode.

21. The apparatus of claim 1, wherein the payload comprises:
at least one monitoring device.

22. The apparatus of claim 1, wherein the payload comprises at least one of:
a memory for storing information collected by the payload at the location; and
a transmitter for transmitting information collected by the payload at the location.

23. An apparatus adapted for being ejected from a mount, comprising:
a controller adapted for generating a control signal;
a breaking means adapted for breaking a securing means that secures the apparatus to the mount using a securing force, thereby causing an ejecting means to eject the apparatus from the mount using an ejecting force, wherein the breaking means breaks the securing means in response to the control signal; and
at least one monitoring component adapted for collecting information.

24. A method for ejecting a payload from a mount attached to a mobile unit, comprising:
generating a control signal adapted to cause a deployment mechanism to transition from the payload securing mode to the payload deployment mode, wherein the deployment mechanism secures the payload to the mount while in the payload securing mode, wherein the deployment mechanism causes the payload to be ejected from the mount while in the payload deployment mode.

25. An apparatus for deploying a payload, comprising:
a mount adapted to be attached to a mobile unit while allowing normal operation of the mobile unit;
an ejecting means coupled to the mount, the ejecting means adapted for ejecting the payload from the mount using an ejecting force applied to the payload;
a securing means coupled to the mount, the securing means adapted for securing the payload to the mount using a securing force applied to the payload, wherein the securing force prevents the ejecting force from ejecting the payload from the mount prior to a control signal being detected; and
a breaking means adapted for breaking the securing means in response to a control signal, thereby causing the ejecting force of the ejecting means to eject the payload from the mount.
